(19) United States
(12) Patent Application Publication
(10) Pub. No.: US 2025/0089150 A1
(43) Pub. Date: Mar. 13, 2025

(54) EUV LIGHT GENERATION SYSTEM AND ELECTRONIC DEVICE MANUFACTURING METHOD

(71) Applicant: Gigaphoton Inc., Tochigi (JP)

(72) Inventors: Yuichi NISHIMURA, Oyama-shi (JP); Yoshifumi UENO, Oyama-shi (JP)

(73) Assignee: Gigaphoton Inc., Tochigi (JP)

(21) Appl. No.: 18/796,333

(22) Filed: Aug. 7, 2024

(30) Foreign Application Priority Data
Sep. 11, 2023 (JP) 2023-146903

(51) Int. Cl. H01S 3/097

(52) U.S. Cl. CPC H05G 2/0086

(57) ABSTRACT

An EUV light generation system includes a processor controlling an actuator which changes an irradiation position of laser light on a target. The processor executes a first control of acquiring a value of a first index related to output values of EUV energy sensors, acquiring a value of a second index related to a ratio of the output values of the EUV energy sensors, and controlling the actuator based on the value of the first index; and a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.

### CROSS-REFERENCE TO RELATED APPLICATIONS

The present application claims the benefit of Japanese Patent Application No. 2023-146903, filed on Sep. 11, 2023, the entire contents of which are hereby incorporated by reference.

### BACKGROUND

### 1. Technical Field

The present disclosure relates to an EUV light generation system and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an apparatus for generating extreme ultraviolet (EUV) light having a wavelength of about 13 nm with a reduced projection reflection optical system.

A system including a laser produced plasma (LPP) type EUV light generation apparatus using plasma generated by irradiating a target substance with laser light has been developed.

### LIST OF DOCUMENTS

### Patent Documents

Patent Document 1: US Patent Application Publication No. 2023/0101779
Patent Document 2: US Patent Application Publication No. 2021/0410262
Patent Document 3: U.S. Pat. No. 8,993,976

### SUMMARY

An EUV light generation system according to an aspect of the present disclosure includes a chamber into which a buffer gas is supplied, a laser device configured to output laser light to be radiated to a target supplied into the chamber, an actuator configured to change an irradiation position of the laser light on the target, a plurality of EUV light sensors configured to detect EUV energy which is energy of EUV light radiated from the target irradiated with the laser light, and a processor configured to control the actuator. Here, the processor executes a first control of acquiring a value of a first index related to output values of the plurality of EUV energy sensors, acquiring a value of a second index related to a ratio of the output values of the plurality of EUV energy sensors, and controlling the actuator based on the value of the first index; and a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.

An electronic device manufacturing method according to an aspect of the present disclosure includes outputting EUV light generated by an EUV light generation system to an exposure system, and exposing a photosensitive substrate to the EUV light in the exposure apparatus to manufacture an electronic device. Here, the EUV light generation system includes a chamber into which a buffer gas is supplied, a laser device configured to output laser light to be radiated to a target supplied into the chamber, an actuator configured to change an irradiation position of the laser light on the target, a plurality of EUV light sensors configured to detect EUV energy which is energy of the EUV light radiated from the target irradiated with the laser light, and a processor configured to control the actuator. The processor executes a first control of acquiring a value of a first index related to output values of the plurality of EUV energy sensors, acquiring a value of a second index related to a ratio of the output values of the plurality of EUV energy sensors, and controlling the actuator based on the value of the first index; and a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.

An electronic device manufacturing method according to an aspect of the present disclosure includes inspecting a defect of a mask by irradiating the mask with EUV light generated by an EUV light generation system, selecting a mask using a result of the inspection, and exposing and transferring a pattern formed on the selected mask onto a photosensitive substrate. Here, the EUV light generation system includes a chamber into which a buffer gas is supplied, a laser device configured to output laser light to be radiated to a target supplied into the chamber, an actuator configured to change an irradiation position of the laser light on the target, a plurality of EUV light sensors configured to detect EUV energy which is energy of the EUV light radiated from the target irradiated with the laser light, and a processor configured to control the actuator. The processor executes a first control of acquiring a value of a first index related to output values of the plurality of EUV energy sensors, acquiring a value of a second index related to a ratio of the output values of the plurality of EUV energy sensors, and controlling the actuator based on the value of the first index; and a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.

### BRIEF DESCRIPTION OF THE DRAWINGS

Embodiments of the present disclosure will be described below merely as examples with reference to the accompanying drawings.

FIG. 1 is a diagram schematically showing the configuration of an LPP EUV light generation system.

FIG. 2 is a diagram showing the configuration of the EUV light generation system according to a comparative example.

FIG. 3 is a diagram showing the arrangement of a plurality of EUV energy sensors.

FIG. 4 is a flowchart showing a processing procedure of laser irradiation position control.

FIG. 5 is a flowchart showing an adjustment algorithm used in light concentrating unit position adjustment and MPL irradiation position adjustment.

FIG. 6 is a flowchart showing position adjustment according to step S100 of FIG. 5.

FIG. 7 is a diagram showing an example of acquiring values of an index.

FIG. 8 is a diagram showing an example of acquiring values of the index.

FIG. 9 is a diagram showing an example of a process for changing an irradiation position in a case in which a gradient is equal to or less than a threshold.

FIG. 10 is a diagram showing an example of a process for additional search and changing the irradiation position in a case in which the gradient is more than the threshold.

FIG. 11 is a diagram showing an example of a process for changing the irradiation position in a case in which the gradient is equal to or less than the threshold.

FIG. 12 is a diagram showing an example of a process for the additional search and changing the irradiation position in a case in which the gradient is more than the threshold.

FIG. 13 is a diagram showing dependency of vibration of the EUV energy on the irradiation position.

FIG. 14 is a flowchart showing details of a position adjustment process executed in the MPL irradiation position adjustment according to a first embodiment.

FIG. 15 is a diagram showing an example of the relationship between an EUV energy centroid position and a stable area.

FIG. 16 is a diagram showing an example of vibration avoiding operation.

FIG. 17 is a flowchart showing an example of a vibration threshold acquisition process.

FIG. 18 is a diagram showing an example of vibration index values acquired at a vibration occurrence area.

FIG. 19 is a diagram showing an example of the vibration index values acquired at the stable area.

FIG. 20 is a diagram showing an example of a vibration threshold determination process.

FIG. 21 is a flowchart showing details of the position adjustment process executed in the MPL irradiation position adjustment according to a modification.

FIG. 22 is a diagram showing the vibration avoiding operation according to the modification.

FIG. 23 is a diagram showing an example of the vibration avoiding operation according to a second embodiment.

FIG. 24 schematically shows the configuration of an exposure apparatus connected to the EUV light generation system.

FIG. 25 schematically shows the configuration of an inspection apparatus connected to the EUV light generation system.

### DESCRIPTION OF EMBODIMENTS

### <Contents>

1. Overall description of EUV light generation system
   1.1 Configuration
   1.2 Operation
2. Comparative example
   2.1 Configuration
   2.2 Operation
   2.3 Problem
3. First Embodiment
   3.1 Configuration
   3.2 Operation
   3.3 Effect
   3.4 Modification
4. Second Embodiment
   4.1 Configuration
   4.2 Operation
   4.3 Effect
5. Third Embodiment
   5.1 Configuration
   5.2 Operation
   5.3 Effect
6. Modification
7. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overall Description of EUV Light Generation System

### 1.1 Configuration

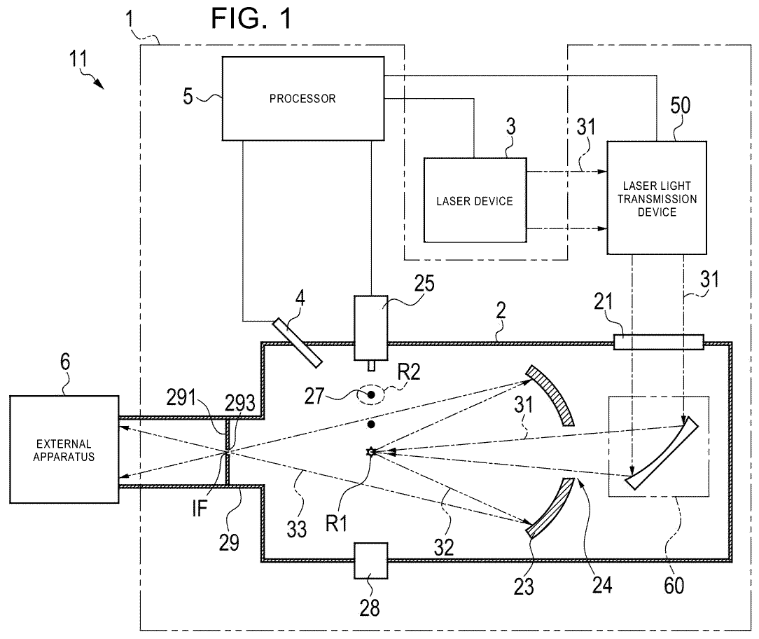

FIG. 1 schematically shows the configuration of an LPP EUV light generation system 11. An EUV light generation apparatus 1 is used together with a laser device 3. In the present disclosure, a system including the EUV light generation apparatus 1 and the laser device 3 is referred to as the EUV light generation system 11. The EUV light generation apparatus 1 includes a chamber 2 and a target supply device 25. The chamber 2 is a sealable container. The target supply device 25 supplies a target 27 in a droplet form into the chamber 2. The material of the target 27 may include tin, terbium, gadolinium, lithium, xenon, or a combination of any two or more thereof.

A through hole is formed in a wall of the chamber 2. The through hole is blocked by a window 21 through which pulse laser light 31 output from the laser device 3 passes. An EUV light concentrating mirror 23 having a spheroidal reflection surface is arranged in the chamber 2. The EUV light concentrating mirror 23 has first and second focal points. A multilayer reflection film in which molybdenum and silicon are alternately stacked is formed on a surface of the EUV light concentrating mirror 23. The EUV light concentrating mirror 23 is arranged such that the first focal point is located in a plasma generation region R1 and the second focal point is located at an intermediate focal point IF. A through hole 24 is formed at the center of the EUV light concentrating mirror 23, and the pulse laser light 31 passes through the through hole 24. The EUV light concentrating mirror 23 is rotationally symmetrical with respect to the optical axis of the pulse laser light 31. The pulse laser light 31 is an example of the “laser light” according to the technology of the present disclosure.

The EUV light generation apparatus 1 includes a target sensor 4, a processor 5, and the like. The target sensor 4 detects at least one of the presence, trajectory, position, and velocity of the target 27. The target sensor 4 may have an imaging function.

The target sensor 4 is a sensor for detecting the target 27 passing through a target detection region R2. The target detection region R2 is a predetermined region in the chamber 2, and is a region located at a predetermined position on the target trajectory between the target supply device 25 and the plasma generation region R1.

The processor 5 is configured by, for example, a central processing unit (CPU). The processor 5 executes various types of processing described above based on a program stored in a memory. Some or all of the functions of the processor 5 may be realized by using an integrated circuit such as a field programmable gate array (FPGA) or an application specific integrated circuit (ASIC).

Further, the EUV light generation apparatus 1 includes a connection portion 29 providing communication between the inside of the chamber 2 and the inside of an external apparatus 6. A wall 291 in which an aperture 293 is formed is arranged in the connection portion 29. The wall 291 is arranged such that the aperture 293 is located at the second focal point of the EUV light concentrating mirror 23. For example, the external apparatus 6 is an exposure apparatus.

Further, the EUV light generation apparatus 1 includes a laser light transmission device 50, a light concentrating unit 60, and a target collection unit 28 for collecting the target 27. The laser light transmission device 50 includes an optical element for defining a transmission state of the laser light, and an actuator for adjusting the position, posture, and the like of the optical element.

Further, a buffer gas is supplied into the chamber 2 from a buffer gas supply device (not shown) to protect the EUV light concentrating mirror 23 from debris generated during plasma generation. In the chamber 2, the buffer gas supplied from a supply port of the buffer gas supply device flows toward a dust removing device (not shown), and a flow field is formed. The buffer gas is hydrogen, nitrogen, or a noble gas such as helium and argon.

### 1.2 Operation

Referring to FIG. 1, operation of an exemplary LPP EUV light generation system 11 will be described. The pulse laser light 31 output from the laser device 3 enters, via the laser light transmission device 50, the chamber 2 through the window 21. The pulse laser light 31 having entered the chamber 2 travels in the chamber 2 along a laser light path, is concentrated by the light concentrating unit 60, and is radiated to the target 27.

The target supply device 25 outputs the target 27 toward the plasma generation region R1 in the chamber 2. The target 27 is irradiated with the pulse laser light 31. The target 27 irradiated with the pulse laser light 31 is turned into plasma, and radiation light 32 is radiated from the plasma. EUV light 33 contained in the radiation light 32 is selectively reflected by the EUV light concentrating mirror 23. The EUV light 33 reflected by the EUV light concentrating mirror 23 is concentrated at the intermediate focal point IF and output to the external apparatus 6. Here, one target 27 may be irradiated with a plurality of pulses included in the pulse laser light 31.

The processor 5 controls the entire EUV light generation system 11. Based on the detection result of the target sensor 4, the processor 5 controls timing at which the target 27 is output, an output direction of the target 27, and the like. Further, the processor 5 controls oscillation timing of the laser device 3, a travel direction of the pulse laser light 31, the concentration position, and the like. The above-described various kinds of control are merely examples, and other control may be added as necessary.

### 2. Comparative Example

### 2.1 Configuration

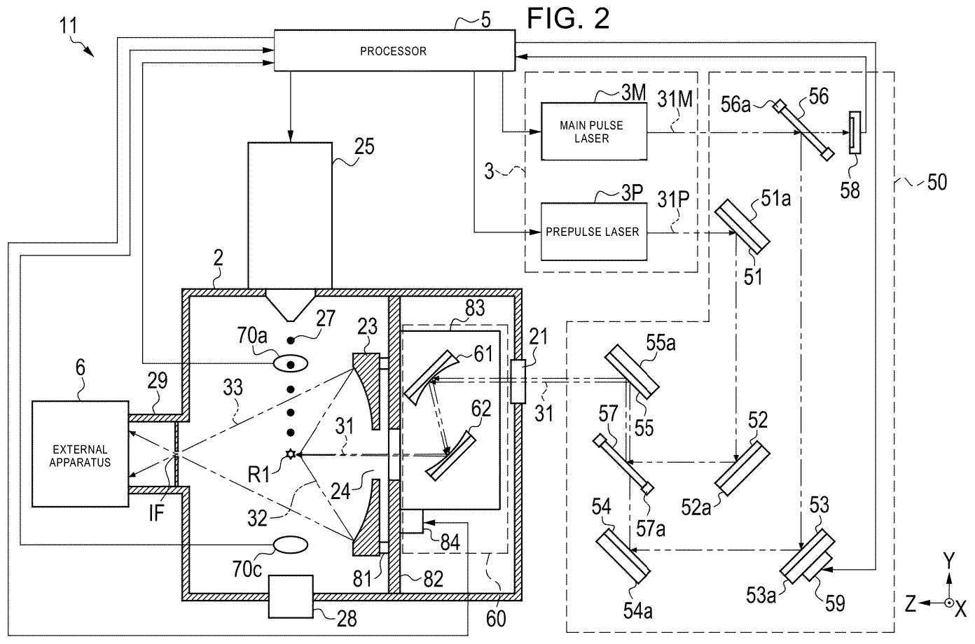

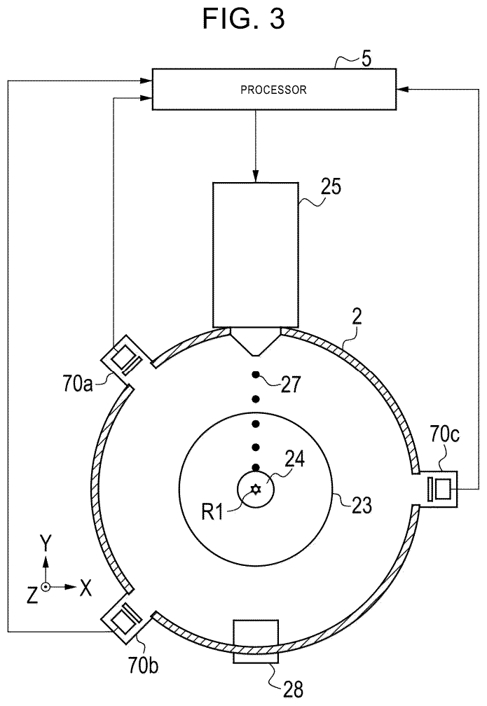

FIG. 2 schematically shows the configuration of the EUV light generation system 11 according to a comparative example. FIG. 3 shows the arrangement of EUV energy sensors 70a to 70c. As shown in FIGS. 2 and 3, the output direction of the EUV light 33 is represented by a Z-axis direction. The direction opposite to the output direction of the target 27 is represented by a Y-axis direction. A direction perpendicular to both the Z-axis direction and the Y-axis direction is represented by an X-axis direction. FIG. 2 shows a YZ cross section of the chamber 2. FIG. 3 shows an XY cross section of the chamber 2.

The light concentrating unit 60, the EUV light concentrating mirror 23, the target collection unit 28, an EUV light concentrating mirror holder 81, plates 82, 83, and a stage 84 are provided in the chamber 2. The target supply device 25 is attached to the chamber 2. As will be described later, the EUV energy sensors 70a to 70c are arranged in the chamber 2.

The target supply device 25 is arranged to penetrate a through hole formed in a wall of the chamber 2. The target supply device 25 stores the molten material of the target 27 therein. The target supply device 25 has an opening located in the chamber 2. A vibrating device (not shown) is arranged in the vicinity of the opening of the target supply device 25.

The target supply device 25 includes an XZ stage (not shown). The processor 5 controls the XZ stage based on the output of the target sensor 4 (see FIG. 1). The trajectory of the target 27 can be adjusted so that the target 27 passes through the plasma generation region R1 by controlling the XZ stage.

The laser device 3 includes a prepulse laser (PPL) 3P and a main pulse laser (MPL) 3M. The PPL 3P is configured to output PPL light 31P. The MPL 3M is configured to output MPL light 31M. The PPL 3P is configured by, for example, a YAG laser device or a laser device using Nd:YVO₄. The MPL 3M is configured by, for example, a CO₂ laser device. The MPL 3M may be configured by a YAG laser device or a laser device using Nd:YVO₄.

The laser light transmission device 50 includes high reflection mirrors 51 to 55, a beam splitter 56, a combiner 57, a laser energy sensor 58, and an actuator 59. The high reflection mirrors 51 to 55, the beam splitter 56, and the combiner 57 are supported by the holders 51a to 57a, respectively.

The high reflection mirror 51 is arranged on the optical path of the PPL light 31P output from the PPL 3P. The high reflection mirror 52 is arranged on the optical path of the PPL light 31P reflected by the high reflection mirror 51.

The beam splitter 56 is arranged on the optical path of the MPL light 31M output from the MPL 3M. The beam splitter 56 is configured to reflect the MPL light 31M at a high reflectance. Further, the beam splitter 56 is configured to transmit a part of the MPL light 31M toward the laser energy sensor 58.

The high reflection mirror 53 is arranged on the optical path of the MPL light 31M reflected by the beam splitter 56. The high reflection mirror 54 is arranged on the optical path of the MPL light 31M reflected by the high reflection mirror 53.

The combiner 57 is arranged at a position where the optical path of the PPL light 31P reflected by the high reflection mirror 52 intersects with the MPL light 31M reflected by the high reflection mirror 54. The combiner 57 is configured to reflect the PPL light 31P with a high reflectance and transmit the MPL light 31M at a high transmittance. The combiner 57 is configured to substantially match the optical path axes of the PPL light 31P and the MPL light 31M.

The high reflection mirror 55 is arranged on the optical path of the PPL light 31P reflected by the combiner 57 and the optical path of the MPL light 31M transmitted through the combiner 57. The high reflection mirror 55 is configured to reflect the PPL light 31P and the MPL light 31M toward the inside of the chamber 2. In the present disclosure, for convenience of explanation, the PPL light 31P and the MPL light 31M reflected by the high reflection mirror 55 may be collectively referred to as the pulse laser light 31.

The actuator 59 is attached to the holder 53a. The actuator 59 is connected to the processor 5, and is configured to be able to control the optical path axis of the MPL light 31M by changing the posture of the high reflection mirror 53. The actuator 59 is not limited to the above arrangement. The actuator 59 may be configured to be able to control the posture of any of the high reflection mirrors arranged on the optical path of the MPL light 31M. The high reflection mirror 53 is an example of the “mirror” according to the technology of the present disclosure.

The laser energy sensor 58 is arranged on the optical path of the MPL light 31M transmitted through the beam splitter 56. The laser energy sensor 58 measures the energy of the MPL light 31M transmitted through the beam splitter 56 and outputs the measurement energy to the processor 5. The laser energy sensor 58 is not limited to the above arrangement. The laser energy sensor 58 may be arranged such that any of the high reflection mirrors arranged on the optical path of the MPL light 31M is changed to a beam splitter to measure light transmitted therethrough.

The plate 82 is fixed to the chamber 2. The plate 82 supports the plate 83. The light concentrating unit 60 includes laser light concentrating mirrors 61, 62.

The stage 84 is capable of adjusting the position of the plate 83 with respect to the plate 82. By adjusting the position of the plate 83, the position of the light concentrating unit 60 is adjusted. The position of the light concentrating unit 60 is adjusted so that the pulse laser light 31 reflected by the laser light concentrating mirrors 61, 62 is concentrated at the plasma generation region R1.

The EUV light concentrating mirror 23 is fixed to the plate 82 via the EUV light concentrating mirror holder 81.

As shown in FIG. 3, the EUV energy sensors 70a to 70c are attached to the wall surface of the chamber 2. Each of the EUV energy sensors 70a to 70c is directed to the plasma generation region R1. The EUV energy sensors 70a, 70b are arranged at positions to be a mirror image with respect to each other across a virtual plane being parallel to the XZ plane and passing through the plasma generation region R1. The EUV energy sensor 70c is arranged on the opposite side of the EUV energy sensors 70a, 70b across a virtual plane being parallel to the YZ plane and passing through the plasma generation region R1 and on a virtual line being parallel to the Z axis and passing through the plasma generation region R1. Each of the EUV energy sensors 70a to 70c measures the energy of the EUV light 33 included in the radiation light 32 emitted from the target 27 in the plasma generation region R1, and outputs the measurement energy to the processor 5. Hereinafter, the energy of the EUV light 33 is referred to as the EUV energy.

### 2.2 Operation

The processor 5 outputs a control signal to the target supply device 25. The target substance stored in the target supply device 25 is maintained at a temperature equal to or higher than the melting point of the target substance by a heater (not shown). The target substance in the target supply device 25 is pressurized by an inert gas supplied from a gas supply device (not shown) into the target supply device 25.

The target substance pressurized by the inert gas is output as a jet through the above-described opening. The jet of the target substance is separated into a plurality of droplets by vibrating components of the target supply device 25 at least around the opening by the above-described vibration device. Each droplet constitutes the target 27. The target 27 moves in the −Y-axis direction along the trajectory from the target supply device 25 to the plasma generation region R1. The target collection unit 28 collects the target 27 having passed through the plasma generation region R1.

The target 27 output into the chamber 2 passes through the target detection region R2. The target 27 having passed through the target detection region R2 is supplied to the plasma generation region R1.

The target sensor 4 detects the timing at which the target 27 passes through the target detection region R2. The processor 5 receives a passage timing signal transmitted from the target sensor 4. The processor 5 determines the timing at which the passage timing signal becomes lower than a predetermined threshold as the timing at which the target 27 passes through the target detection region R2. That is, the processor 5 specifies the timing at which the target 27 passes through the target detection region R2 based on the detection result of the target sensor 4. The processor 5 generates a target detection signal indicating that the target 27 passes through the target detection region R2 at the timing at which the passage timing signal becomes lower than the predetermined threshold.

The processor 5 outputs a first trigger signal to the PPL 3P at a timing delayed by a predetermined delay time from the timing at which the target detection signal is generated, the first trigger signal giving a trigger to output the PPL light 31P. The PPL 3P outputs the PPL light 31P in accordance with the first trigger signal. The processor 5 outputs a second trigger signal to the MPL 3M after outputting the first trigger signal. The MPL 3M outputs the MPL light 31M in accordance with the second trigger signal. Thus, the laser device 3 outputs the PPL light 31P and the MPL light 31M in this order. The PPL light 31P preferably has a pulse time width on the order of picoseconds. The order of picoseconds means being equal to or more than 1 ps and equal to or less than 1 ns. Here, the pulse time width of the PPL light 31P may be equal to or more than 1 ns and equal to or less than 1 μs.

The PPL light 31P and the MPL light 31M enter the laser light transmission device 50. The PPL light 31P and the MPL light 31M are guided to the light concentrating unit 60 as the pulse laser light 31 via the laser light transmission device 50. The pulse laser light 31 is reflected by the laser light concentrating mirror 61. The pulse laser light 31 reflected by the laser light concentrating mirror 61 is reflected by the laser light concentrating mirror 62 and is concentrated at the plasma generation region R1.

The stage 84 changes the position of the plate 83 with respect to the plate 82 by a control signal output from the processor 5. By changing the position of the plate 83, the position of the light concentrating unit 60 is moved. As the light concentrating unit 60 is moved, the irradiation positions of the PPL light 31P and the MPL light 31M are moved.

Further, the actuator 59 changes the posture of the high reflection mirror 53 according to a control signal output from the processor 5. By changing the posture of the high reflection mirror 53, the irradiation position of the MPL light 31M is moved.

At the timing at which one target 27 reaches the plasma generation region R1, the target 27 is irradiated with the PPL light 31P. The target 27 irradiated with the PPL light 31P is diffused into a mist form. At the timing at which the target 27 is diffused into a desired size, the target 27 is irradiated with the MPL light 31M.

The target 27 irradiated with the MPL light 31M is turned into plasma and emits the radiation light 32. The EUV light 33 included in the radiation light 32 is selectively reflected by the EUV light concentrating mirror 23 and is concentrated on the intermediate focal point IF at the connection portion 29. The EUV light 33 concentrated on the intermediate focal point IF is output toward the external apparatus 6.

When the optical path axis of the pulse laser light 31 concentrated at the plasma generation region R1 deviates from the center of the droplet form target 27, a problem such as a decrease in the EUV energy occurs. However, it may be difficult to directly measure the deviation between the optical path axis of the pulse laser light 31 and the center of the target 27. Therefore, the processor 120 controls the pulse energy of the MPL light 31M such that the EUV energy becomes constant during continuous operation of the EUV light generation system 11. For example, the processor 5 controls the pulse energy of the MPL light 31M such that the sum or average of the output values of the EUV energy sensors 70a to 70c falls within a predetermined range. Hereinafter, the pulse energy of the MPL light 31M at the plasma generation region R1 is referred to as the MPL energy.

However, it is difficult to maintain the EUV energy constant only by controlling the MPL energy. This is because the thermal deformation of the optical elements on the optical path changes the characteristics of the EUV energy. Therefore, in the present comparative example, the processor 5 performs laser irradiation position control using EUV energy 3σ which is an index indicating the temporal deviation of the EUV energy and CE which is an index indicating the conversion efficiency of the MPL energy to the EUV energy. Here, CE is a value obtained by dividing the sum or average of the output values of the EUV energy sensors 70a to 70c by the MPL energy. Hereinafter, the EUV energy 3σ is referred to as E3σ.

For example, E3σ is calculated by the following expression (1). The unit of E3σ is %.

$$\begin{matrix}[ Expression 1 ] & \\ E 3 σ = ( 3 σ / μ ) \times 100 … & ( 1 )\end{matrix}$$

Here, σ is a standard deviation of the EUV energy for a plurality of pulses included in a unit time. Further, μ is the average value of the EUV energy for multiple pulses included in the unit time. For example, the EUV energy used to calculate E3σ is the sum or average of the output values of the EUV energy sensors 70a to 70c. The unit time is several seconds, for example, about 1 to 5 seconds. The index indicating the temporal deviation of the EUV energy is not limited to E3σ, and may be, for example, a value obtained by multiplying the standard deviation a by an integral number.

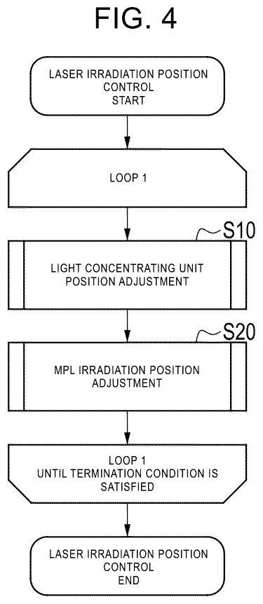

FIG. 4 shows a processing procedure of the laser irradiation position control. In the laser irradiation position control, the processor 5 executes loop 1 including a process of alternately performing light concentrating unit position adjustment (step S10) for adjusting the position of the light concentrating unit 60 and MPL irradiation position adjustment (step S20) for adjusting the irradiation position of the MPL light 31M. When a predetermined termination condition is satisfied, the processor 5 exits loop 1 and terminates the laser irradiation position control. The termination condition of loop 1 is detection of transition to a state involving stop of EUV light generation such as receiving an EUV light output stop command input from the external apparatus 6, for example.

In step S10, the processor 5 performs the light concentrating unit position adjustment by controlling the stage 84 using E3σ as an index. In step S20, the processor 5 performs the MPL irradiation position adjustment by controlling the actuator 59 using CE as an index.

The processor 5 can execute the light concentrating unit position adjustment and the MPL irradiation position adjustment using a common adjustment algorithm. Here, the index, a search width Δ, and an allowable value of the positional deviation, which will be described later, are different between the light concentrating unit position adjustment and the MPL irradiation position adjustment.

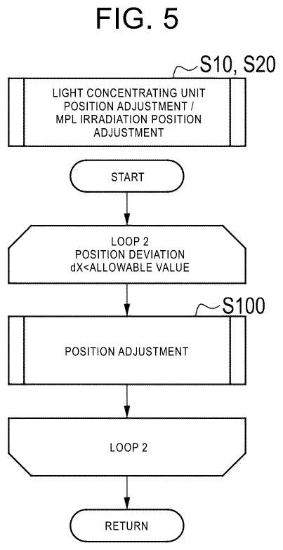

FIG. 5 shows the adjustment algorithm used in the light concentrating unit position adjustment and the MPL irradiation position adjustment. According to the adjustment algorithm, the processor 5 executes loop 2 including a process of repeatedly performing the position adjustment (step S100). In loop 2, the processor 5 changes an adjustment target axis each time the position adjustment is performed. The processor 5 repeats the position adjustment in the X-axis direction and the position adjustment in the Y-axis direction in the order of the X axis, the Y axis, the X-axis, . . . , or in the order of the Y axis, the X axis, the Y axis, . . . .

When a predetermined termination condition is satisfied, the processor 5 exits loop 2 and terminates the position adjustment. The termination condition of loop 2 is, for example, that the positional deviation dX becomes less than an allowable value. The positional deviation dX is, for example, with the position adjustment in the X-axis direction performed twice consecutively, an absolute value of the difference between a position adjusted by the first position adjustment in the X-axis direction and a position adjusted by the second position adjustment in the X-axis direction. When the positional deviation dX is equal to or more than the allowable value, the processor 5 continues the position adjustment with the second adjustment position in the X-axis direction set as the first adjustment position. Here, the allowable value is an upper limit value of the positional deviation at which no significant improvement can be expected even if the position adjustment is performed continuously.

Incidentally, the light concentrating unit position adjustment corresponds to the adjustment of the irradiation positions of the PPL light 31P and the MPL light 31M. Therefore, hereinafter, when simply referred to as the irradiation position, the irradiation position of the PPL light 31P is also included in addition to the irradiation position of the MPL light 31M.

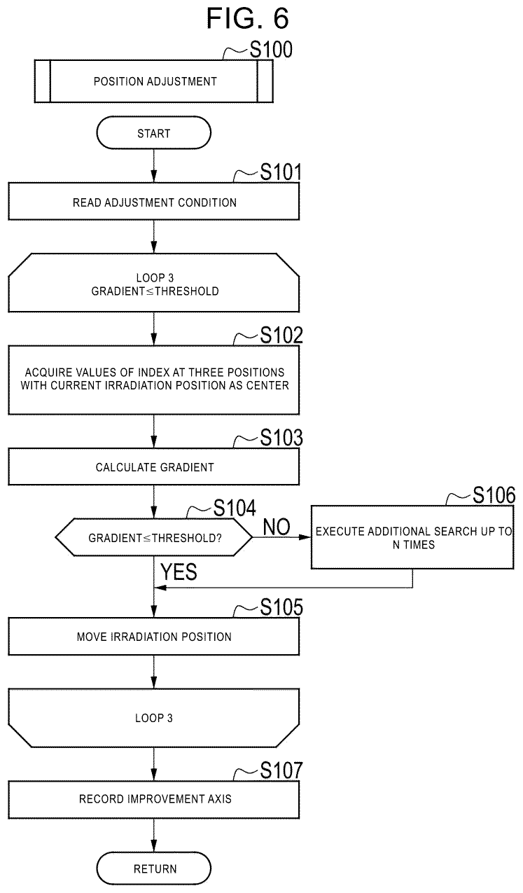

FIG. 6 shows details of the position adjustment according to step S100 of FIG. 5. First, the processor 5 reads an adjustment condition from the memory (step S101). For example, the adjustment condition includes a current irradiation position, an adjustment target axis, a threshold, the search width Δ, a minute amount d, and a number of additional searches N. The search width Δ is about 0.5 to 5 μm. The search width Δ may have different values in the X-axis direction and the Y-axis direction. In particular, when the spot intensity distribution of the pulse laser light 31 is elliptic, it is preferable to set different values in the X-axis direction and the Y-axis direction.

Next, the processor 5 executes loop 3 in which the termination condition is that the gradient of an index becomes equal to or less than the threshold. In loop 3, the processor 5 first acquires values of the index at three positions with the current irradiation position as the center. (step S102). Specifically, the processor 5 changes the irradiation position in the direction of the adjustment target axis by ±Δ from the current irradiation position, and acquires values of the index at the three positions. The irradiation position moved in the position adjustment according to step S100 is also referred to as a search position. When the position of the light concentrating unit 60 is to be changed, the index is E3σ. When the irradiation position of the MPL light 31M is to be changed, the index is CE.

Next, the processor 5 calculates the gradient of the index with respect to the search position based on the acquired values of the index at the three positions (step S103). For example, the gradient is an absolute value of the gradient of a linear approximation line calculated based on the values of the index at the three positions.

Next, the processor 5 determines whether or not the calculated gradient is equal to or less than the threshold (step S104). When the gradient is equal to or less than the threshold (step S104: YES), the processor 5 advances processing to step S105.

On the other hand, when the gradient is more than the threshold (step S104: NO), the processor 5 executes additional searches up to N times (step S106), and advances processing to step S105. The additional search is a process of acquiring values of the index while changing the search position by the search width Δ in the direction in which the index improves, and searching an improvement position. Specifically, the processor 5 evaluates the values of the index while changing the search position in the improvement direction, and sets the search position immediately before the value of the index deteriorates as the improvement position. Here, in a case in which values of the index continues to be improved without deteriorating even when the search position is changed N times, the N-th change position is set as the improvement position. When the index is E3σ, the direction in which the value of the index decreases is the improvement direction. When the index is CE, the direction in which the value of the index increases is the improvement direction.

In step S105, the processor 5 moves the irradiation position. Specifically, when the gradient is equal to or less than the threshold, the processor 5 moves the irradiation position by a minute amount d in the improvement direction. The minute amount d is a value equal to or less than the search width Δ. When the gradient is more than the threshold and the additional search is performed, the processor 5 moves the irradiation position to the improvement position.

The processor 5 repeatedly executes steps S102 to S106 until the gradient becomes equal to or less than the threshold, and when the gradient becomes equal to or less than the threshold, terminates loop 3, records the improvement axis in the memory (step S107), and terminates the process. The improvement axis is a coordinate axis improved by the additional search, and is the X axis or the Y axis. The improvement axis is stored in the memory in an overwritten manner, and is read as the adjustment target axis by the processor 5 in step S101 at the time of the next position adjustment. When the processor 5 terminates loop 3 without performing the additional search, the process is terminated without executing step S107.

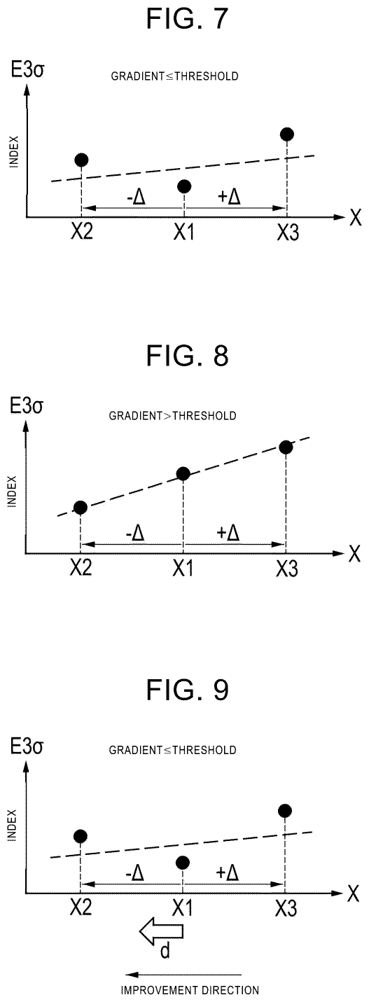

FIGS. 7 and 8 show examples of acquiring values of the index. In FIGS. 7 and 8, the index is E3σ and the adjustment target axis is the X axis. X1 indicates the current irradiation position. X2 indicates a search position changed by −Δ from the irradiation position X1 in the X-axis direction. X3 indicates a search position changed by +Δ from the irradiation position X1 in the X-axis direction. The broken line is a linear approximation line. FIG. 7 shows a case in which the gradient is equal to or less than the threshold. FIG. 8 shows a case in which the gradient is more than the threshold.

FIG. 9 shows an example of a process for changing the irradiation position in a case in which the gradient is equal to or less than the threshold. In the example shown in FIG. 9, since the direction from the irradiation position X1 toward the search position X2 is the direction in which E3σ improves, the irradiation position X1 is changed by the minute amount d in the direction toward the search position X2.

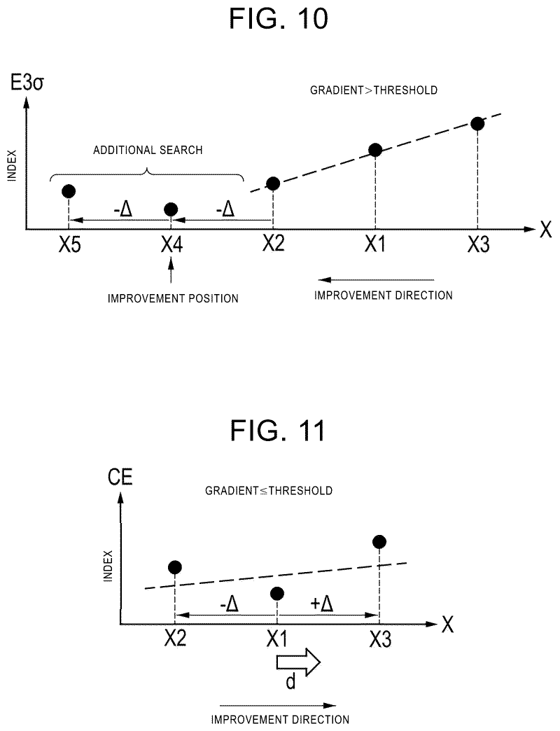

FIG. 10 shows an example of a process for additional search and changing the irradiation position in a case in which the gradient is more than the threshold. In the example shown in FIG. 10, since the direction from the irradiation position X1 toward the search position X2 is the direction in which E3σ improves, additional search is performed in the direction opposite to the irradiation position X1 from the search position X2. In the example shown in FIG. 10, values of the index are acquired at the search position X4 changed from the search position X2 by −Δ and the search position X5 changed from the search position X4 by −Δ. Since the value of the index at the search position X5 is deteriorated from the value of the index at the search position X4, the search position X4 is the improvement position.

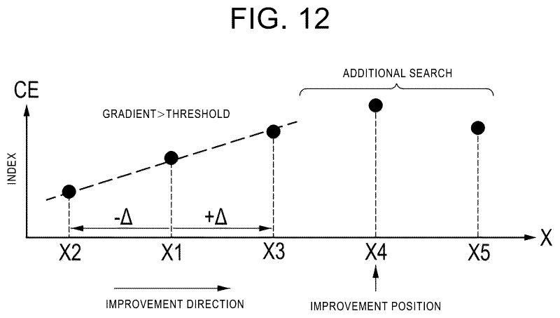

FIGS. 11 and 12 show a case in which the index is CE. FIG. 11 shows an example of a process for changing the irradiation position in a case in which the gradient is equal to or less than the threshold. In the example shown in FIG. 11, since the direction from the irradiation position X1 toward the search position X3 is the direction in which CE improves, the irradiation position X1 is changed by the minute amount d in the direction toward the search position X3.

FIG. 12 shows an example of a process for additional search and changing the irradiation position in a case in which the gradient is more than the threshold. In the example shown in FIG. 12, since the direction from the irradiation position X1 toward the search position X3 is the direction in which CE improves, additional search is performed in the direction opposite to the irradiation position X1 from the search position X3. In the example shown in FIG. 12, values of the index are acquired at the search position X4 changed from the search position X3 by +Δ and the search position X5 changed from the search position X4 by +A. Since the value of the index at the search position X5 is deteriorated from the value of the index at the search position X4, the search position X4 is the improvement position.

### 2.3 Problem

In the EUV light generation system 11 according to the comparative example, since the irradiation position of the pulse laser light 31 on the target 27 is controlled by controlling the irradiation position of the MPL light 31M using CE as the index in addition to adjusting the position of the light concentrating unit 60 using E3σ as the index, the EUV energy is stabilized. Further, by operating the EUV light generation system 11 under the condition that CE is high, the generation of fragment debris is reduced and contamination of the EUV light concentrating mirror 23 is reduced, and thus the lifetime of the EUV light concentrating mirror 23 is improved. Fragment debris is generated when the pulse laser light 31 is radiated at a position deviated from the center of the target 27. Specifically, fragment debris is a minute droplet that is not turned into plasma by the MPL light 31M among the target 27 diffused by the irradiation with the PPL light 31P.

However, even in the EUV light generation system 11 according to the comparative example, when the irradiation position deviates from the optimum position during continuous operation, there arises a phenomenon in which the temporal vibration of the EUV energy increases.

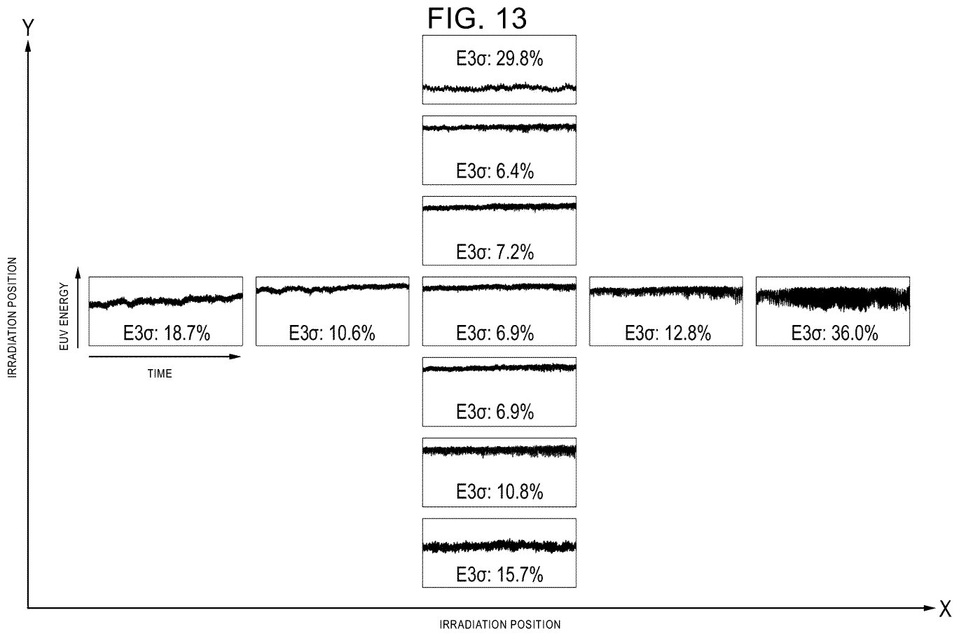

FIG. 13 shows dependency of the vibration of the EUV energy on the irradiation position. In FIG. 13, the horizontal axis represents the deviation amount of the irradiation position on the target 27 in the X axis, and the vertical axis represents the deviation amount of the irradiation position on the target 27 in the Y axis. A small graph in each deviation amount represents a temporal change of the EUV energy. Further, in the graphs of FIG. 13, the values of E3σ, which is an index related to the vibration amount of the EUV energy, are shown. According to FIG. 13, it can be understood that there is an area in which the EUV energy temporally vibrates when the deviation amount of the irradiation position on the target 27 in the X-axis direction is large. It is considered that the vibration of the EUV energy is caused by the vibration of the position of the target 27 on the flow field of the buffer gas due to the variation of the density of the buffer gas in the chamber 2 due to heat generation at the time of plasma generation. Therefore, it is considered that the vibration characteristics such as the vibration frequency of the EUV energy and the deviation direction of the irradiation position at which vibration occurs depend on the internal structure of the chamber 2, the flow field of the buffer gas, and the like.

During vibration of the EUV energy, it is considered that fragment debris is generated by miss shooting of the pulse laser light 31 on the target 27. Accordingly, it is desired to realize laser irradiation position control in which the effect of vibration of EUV energy is suppressed.

### 3. First Embodiment

The EUV light generation system according to a first embodiment will be described. Duplicate description of the same configuration and operation as those of the comparative example will be omitted unless specific description is needed.

### 3.1 Configuration

The configuration of the EUV light generation system according to the present embodiment is similar to the configuration of the EUV light generation system 11 according to the comparative example except that the processor 5 is configured to execute a process different from that in the comparative example.

### 3.2 Operation

The operation of the EUV light generation system according to the present embodiment is similar to the operation of the EUV light generation system 11 according to the comparative embodiment except that the position adjustment process (step S100) executed in the MPL irradiation position adjustment (S20) of the laser irradiation position control is different. Here, the position adjustment process (step S100) executed in the light concentrating unit position adjustment (step S10) is similar to that in the comparative embodiment.

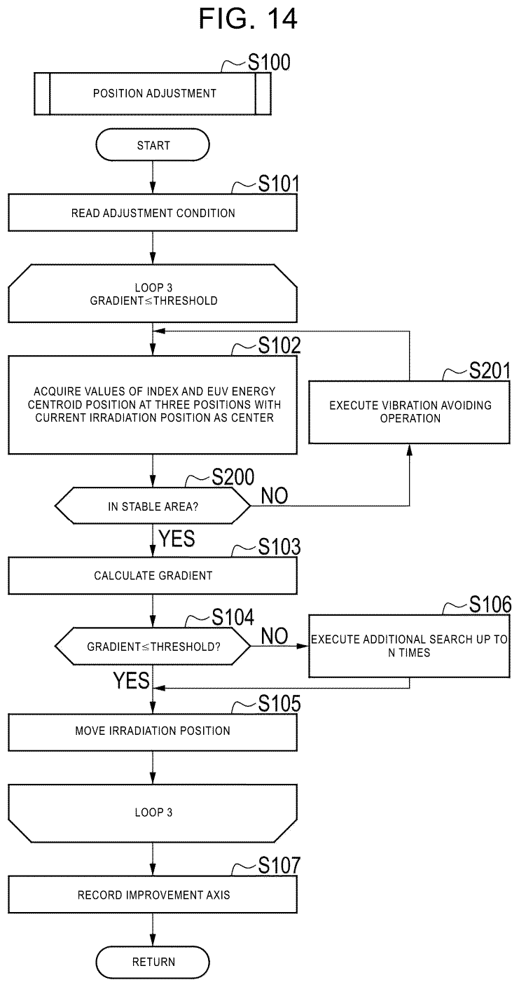

FIG. 14 shows details of the position adjustment process executed in the MPL irradiation position adjustment according to the first embodiment. The position adjustment process shown in FIG. 14 is similar to the position adjustment process shown in FIG. 6 except that the content executed in step S102 is partially different and steps S200 and S201 are added.

In the present embodiment, in step S102, the processor 5 acquires EUV energy centroid positions in addition to the values of the index at three positions with the current irradiation position as the center. Specifically, the processor 5 acquires the EUV energy centroid position using the following expression (2) or (3) in correspondence with the adjustment target axis using the output values of the EUV energy sensors 70a to 70c.

$$\begin{matrix}[ Expression 2 ] & \\ Cx = ( {a}_{x} {E}_{1} + {b}_{x} {E}_{2} + {c}_{x} {E}_{3} ) / ( {d}_{x} {E}_{1} + {e}_{x} {E}_{2} + {f}_{x} {E}_{3} ) & ( 2 )\end{matrix}$$

$$\begin{matrix}[ Expression 3 ] & \\ Cy = ( {a}_{Y} {E}_{1} + {b}_{Y} {E}_{2} + {c}_{Y} {E}_{3} ) / ( {d}_{Y} {E}_{1} + {e}_{Y} {E}_{2} + {f}_{Y} {E}_{3} ) & ( 3 )\end{matrix}$$

Here, Cx is an X-axis coordinate of the EUV energy centroid position. Cy is a Y-axis coordinate of the EUV energy centroid position. E₁ is the output value of the EUV energy sensor 70a. E₂ is the output value of the EUV energy sensor 70b. E₃ is the output value of the EUV energy sensor 70c. Each of ax, bx, cx, dx, ex, fx, ay, by, cy, dy, ey, and fy is a coefficient. The EUV energy centroid position is a spatial centroid position of the EUV energy calculated from a plurality of measurement values obtained by measuring, at a plurality of different positions, the EUV energy radiated from the target 27.

The processor 5 acquires the X-axis coordinate Cx of the EUV energy centroid position based on the above expression (1) when the adjustment target axis is the X axis, and acquires the Y-axis coordinate Cy of the EUV energy centroid position based on the above expression (2) when the adjustment target axis is the Y axis.

Next, the processor 5 determines whether all three EUV energy centroid positions acquired in step S102 are in a stable area (step S200). When the three EUV energy centroid positions are all in the stable area (step S200: YES), the processor 5 advances processing to step S103. On the other hand, when at least one of the three EUV energy centroid positions is not in the stable area (step S200: NO), the processor 5 executes vibration avoiding operation (step S201), and returns processing to step S102. The processor 5 repeatedly performs steps S102 to S201 until all three EUV energy centroid positions fall within the stable area.

In FIG. 14, since adjustment of the irradiation position of the MPL light 31M is performed, in step S102, the value of CE is acquired at three positions with the current irradiation position as the center. Further, as will be described in detail later, in step S201, the actuator 59 is controlled to move the irradiation position of the MPL light 31M to a position where all three EUV energy centroid positions are in the stable area. Therefore, in the present embodiment, a first control for controlling the actuator 59 based on CE is performed, and during the first control, a second control for controlling the actuator 59 based on the EUV energy centroid position is performed. Here, CE is an example of the “first index related to output values of a plurality of EUV energy sensors” according to the technology of the present disclosure. The EUV energy centroid position corresponds to the “second index related to a ratio of the output values of EUV energy sensors” according to the technology of the present disclosure. Further, the actuator 59 is an example of the “actuator” according to the technology of the present disclosure.

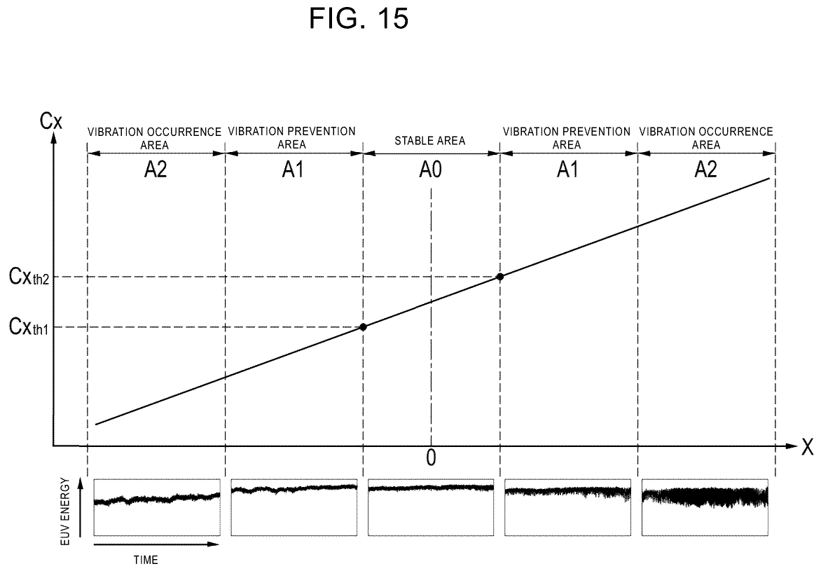

FIG. 15 shows an example of the relationship between the EUV energy centroid position and the stable area. In FIG. 15, the horizontal axis represents the deviation amount of the irradiation position on the target 27 in the X-axis direction, and the vertical axis represents the X-axis coordinate Cx of the EUV energy centroid position.

The EUV energy centroid position belongs to any of a stable area A0, a vibration prevention area A1, and a vibration occurrence area A2. FIG. 15 shows vibration of the EUV energy in the respective areas. The stable area A0 is an area in which the vibration of the EUV energy is small and stable. The vibration occurrence area A2 is an area in which a certain vibration or more is generated. The vibration prevention area A1 is an area in which the vibration is less than a certain level and is an area set between the stable area A0 and the vibration occurrence area A2 to prevent vibration.

Cxₜₕ₁ is a threshold at the lower limit side of the stable area A0. Cxₜₕ₂ is a threshold at the upper limit side of the stable area A0. Hereinafter, Cxₜₕ₁ and Cxₜₕ₂ are referred to as vibration thresholds. The threshold Cyₜₕ₁ on the lower limit side and the threshold Cyₜₕ₂ on the upper limit side of the stable area A0 in a case in which the adjustment target axis is the Y axis are also referred to as the vibration thresholds hereinafter.

When all X-axis coordinates Cx of the EUV energy centroid positions at all three positions satisfy Cxₜₕ₁≤Cx≤Cxₜₕ₂ in step S201 described above, the processor 5 determines that the position is in the stable area A0. When at least one of the X-axis coordinates Cx of the EUV energy centroid positions at the three positions satisfy Cxₜₕ₁>Cx or Cxₜₕ₂<Cx, the processor 5 determines that the position is not in the stable area A0.

FIG. 15 is an example of a case in which the adjustment target axis is the X axis, but the same applies to a case in which the adjustment target axis is the Y axis. In the case in which the adjustment target axis is the Y axis, the processor 5 determines that the position is in the stable area A0 when all the Y-axis coordinates Cy of the EUV energy centroid positions at the three positions satisfy Cyₜₕ₁<Cy≤Cyₜₕ₂ in S201. When at least one of the Y-axis coordinates Cy of the EUV energy centroid positions at the three positions satisfy Cyₜₕ₁>Cy or Cyₜₕ₂<Cy, the processor 5 determines that the position is not in the stable area A0.

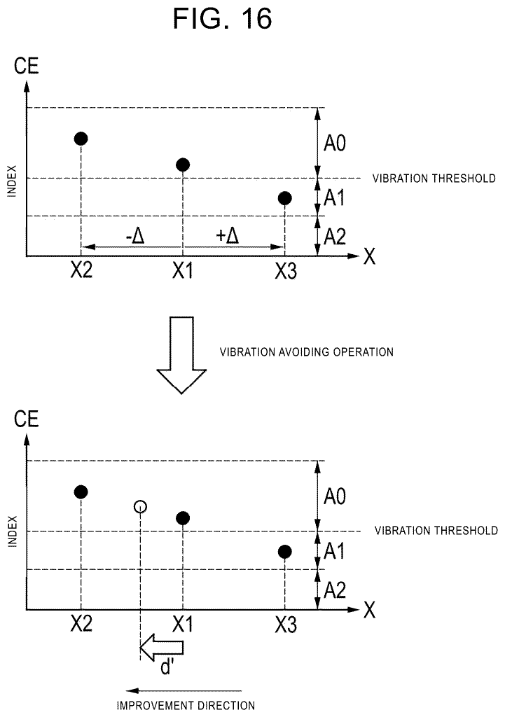

FIG. 16 shows an example of the vibration avoiding operation. FIG. 16 shows a case in which one of the X-axis coordinates Cx of the EUV energy centroid positions at the three positions satisfies Cxₜₕ₁>Cx or Cxₜₕ₂<Cx. In FIG. 16, the relationship between the EUV energy centroid position and the stable area A0, the vibration prevention area A1, and the vibration occurrence area A2 is shown in addition to the X-axis direction dependency of CE.

In the example shown in FIG. 16, since the X-axis coordinate Cx at the search position X3 is not in the stable area A0, that is, exceeds the vibration threshold, the processor 5 executes the vibration avoiding operation. In the vibration avoiding operation, the processor 5 moves the irradiation position X1 in a direction for preventing the X-axis coordinate Cx at the search position X3 from exceeding the vibration threshold.

For example, the processor 5 moves the irradiation position X1 by a distance d′ in a direction in which CE improves, and thus the X-axis coordinate Cx at the search position X3 falls within the stable area A0. The processor 5 may perform determination based on the X-axis coordinates Cx of the EUV energy centroid positions at the three positions X1, X2, X3. For example, the distance d′ is a fixed value, and is included in the adjustment condition read from the memory in step S101. The distance d′ may have different values in the X-axis direction and the Y-axis direction. Here, the processor 5 may adjust the distance d′ based on the X-axis coordinates Cx of the EUV energy centroid positions at the three positions X1, X2, X3. For example, the distance d′ is adjusted so that all X-axis coordinates Cx fall in the stable area A0.

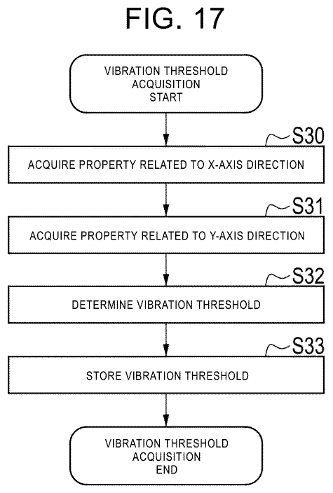

Next, the vibration threshold will be described. The processor 5 previously acquires and holds the vibration threshold. FIG. 17 shows an example of a vibration threshold acquisition process. In the vibration threshold acquisition process, the processor 5 first acquires the property related to the X-axis direction (step S30). Specifically, the EUV energy centroid positions and vibration index values are acquired while controlling the actuator 59 to change the irradiation position of the MPL light 31M on the target 27 repeatedly by a predetermined amount in the X-axis direction. Next, the processor 5 acquires the property related to the Y-axis direction (step S31). Specifically, the EUV energy centroid positions and the vibration index values are acquired while controlling the actuator 59 to change the irradiation position of the MPL light 31M on the target 27 repeatedly by a predetermined amount in the Y-axis direction. The vibration index value is an index indicating the vibration amount of the EUV energy.

Next, the processor 5 determines vibration thresholds in the X-axis direction and the Y-direction based on the data of the acquired EUV energy centroid position and the vibration index value (step S32). The processor 5 stores the determined vibration thresholds in the memory (step S33). Thus, the vibration threshold acquisition process is completed.

Next, the vibration index value will be described. For example, the vibration index value is an integration value Iₙ of a CE relative decrease amount per unit pulse number. The integration value Iₙ is calculated using the following expressions (4) to (7).

$$\begin{matrix}[ Expression 4 ] & \\ {I}_{n} = {\sum }_{i = 1}^{n} {K}_{i} d C {E}_{i} & ( 4 )\end{matrix}$$

$$\begin{matrix}[ Expression 5 ] & \\ dC {E}_{i} = 1 - {CE}_{NRM} & ( 5 )\end{matrix}$$

$$\begin{matrix}[ Expression 6 ] & \\ {CE}_{NRM} = {CE}_{i} / C {E}_{S T} & ( 6 )\end{matrix}$$

$$\begin{matrix}[ Expression 7 ] & \\ {K}_{i} = \{ \begin{matrix}0 , & dC {E}_{i} < dC {E}_{th} \\ 1 , & dC {E}_{i} \geq dC {E}_{th}\end{matrix} & ( 7 )\end{matrix}$$

Here, n is the unit pulse number, for example, 1000. CEᵢ is a measurement value of CE at the time of the i-th pulse irradiation. CE_{ST} is a standard value of CE. CE_{NRM} is normalized CE obtained by normalizing CEᵢ by CEST. Here, dCEᵢ is the CE relative decrease amount representing a decrease amount of the normalized CE at the time of the i-th pulse irradiation. Kᵢ is a coefficient of the CE relative decrease amount dCEᵢ. The coefficient Kᵢ is 0 when dCEᵢ<dCEₜₕ and 1 when dCEᵢ>dCEₜₕ. Further, dCEₜₕ is a threshold and is a value of about 0.1 to 0.5. In the present embodiment, dCEₜₕ=0.3.

According to the above expressions (4) to (7), the integration value Iₙ is a value obtained by integrating the CE relative decrease amount dCEᵢ of the pulses in which the CE relative decrease amount dCEᵢ is less than the threshold dCEₜₕ. The integration value Iₙ increases as the vibration amount of the EUV energy increases.

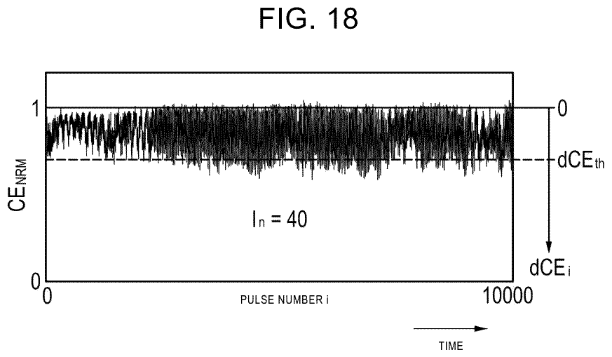

FIG. 18 shows an example of the vibration index values acquired at the vibration occurrence area A2. In the example shown in FIG. 18, the number of pulses in which the CE relative decrease amount dCEᵢ is less than the threshold dCEₜₕ is 1193, and by integrating the CE relative decrease amount dCEᵢ, In is calculated to be 40.

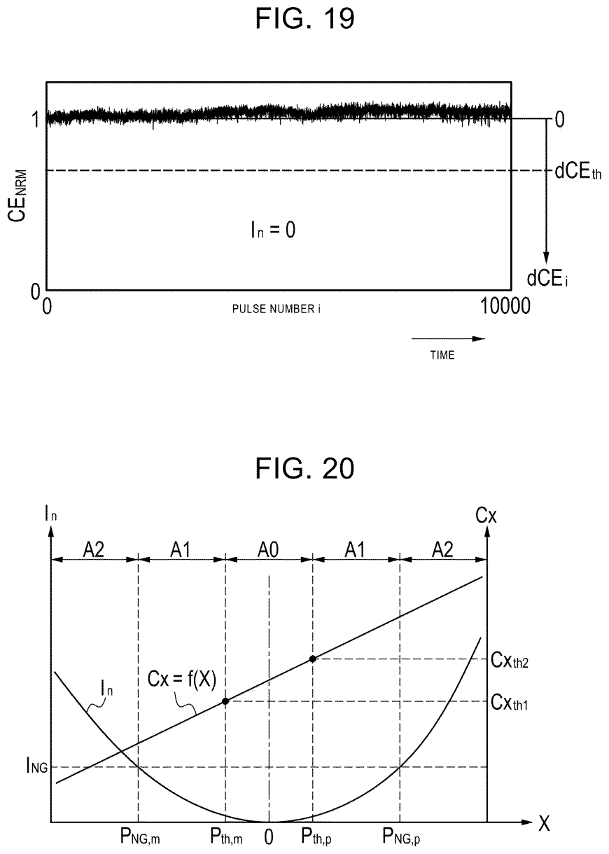

FIG. 19 shows an example of the vibration index values acquired at the stable area A0. In the example shown in FIG. 19, since the number of pulses in which the CE relative decrease amount dCEᵢ is less than the threshold dCEₜₕ is 0, In is calculated to be 0.

FIG. 20 shows an example of a vibration threshold determination process. In FIG. 20, the horizontal axis represents the irradiation position on the target 27, and the vertical axis represents the integration value Iₙ and the X-axis coordinate Cx of the EUV energy centroid position. It has been found by an experiment that the integration value Iₙ with respect to the irradiation position generally forms a downwardly convex curve as shown in FIG. 20.

In the vibration threshold determination process, the processor 5 first obtains the irradiation position at which the integration value Iₙ coincides with a previously set threshold I_{NG}, and stores the obtained irradiation positions as vibration occurrence irradiation positions P_{NG,p}, P_{NG,m}. Assuming that the irradiation position at which the integration value Iₙ becomes the smallest is 0, the vibration occurrence irradiation position P_{NG,p} takes a positive value, and the vibration occurrence irradiation position P_{NG,m} takes a negative value.

The threshold I_{NG} is determined by the adhering rate of fragment debris adhering to the EUV light concentrating mirror 23 and the removing rate of the fragment debris adhering to the EUV light concentrating mirror 23. The fragment debris adhering to the EUV light concentrating mirror 23 chemically reacts with hydrogen or the like contained in the buffer gas excited by the EUV light 33 and is removed as a gas. When the adhering rate exceeds the removing rate, the fragment debris adhering to the EUV light concentrating mirror 23 increases and contamination proceeds. Accordingly, it is preferable that the integration value Iₙ when the adhering rate is equal to or lower than the removing rate is obtained by another experiment or the like and stored.

Next, the processor 5 calculates position deviation thresholds P_{th,p}, P_{th,m} by applying the vibration occurrence irradiation positions P_{NG,p}, P_{NG,m} to the following expressions (8) and (9).

$$\begin{matrix}[ Expression 8 ] & \\ {P}_{t h , p} = {P}_{N G , p} - d {P}_{E} \times S & ( 8 )\end{matrix}$$

$$\begin{matrix}[ Expression 9 ] & \\ {P}_{th , m} = {P}_{NG , m} + d {P}_{E} \times S & ( 9 )\end{matrix}$$

Here, dP_{E} is control deviation of a steady irradiation position. S is a safety factor. As the control deviation dP_{E}, a value three times the relative position deviation of the MPL light 31M on the target 27 estimated from the result of the laser irradiation position control during steady operation may be used. Further, the safety factor S is a value of 1 or more. The safety factor S may be a value previously set based on the result of the laser irradiation position control. The vibration prevention area A1 is defined by the above expressions (8) and (9). The vibration prevention area A1 is an area corresponding to P_{NG,m}≤X≤P_{th,m} and P_{th,p}≤X≤P_{NG,p}.

Next, the processor 5 obtains a function f(X) representing a change in the X-axis coordinate Cx of the EUV energy centroid position with respect to the irradiation position, and calculates the vibration thresholds Cxₜₕ₁, Cxₜₕ₂ by applying the position deviation thresholds P_{th,p}, P_{th,m} to the function f(X). The vibration threshold Cxₜₕ₁ is a value corresponding to the position deviation threshold P_{th,m} on the negative side. The vibration threshold Cxₜₕ₂ is a value corresponding to the position deviation threshold P_{th,p} on the positive side. That is, the vibration thresholds Cxₜₕ₁, Cxₜₕ₂ are values reflecting the vibration occurrence irradiation positions P_{NG,p}, P_{NG,m} which are irradiation positions where the EUV energy vibrates due to the buffer gas.

The processor 5 also determines the vibration thresholds Cyₜₕ₁, Cyₜₕ₂ for the Y-axis direction by a similar process. The vibration index value is not limited to the integration value Iₙ, and may be a value of an index indicating a period, an amplitude, or the like of vibration of the EUV energy.

### 3.3 Effect

As described above, in the present embodiment, a first control for controlling the actuator 59 based on CE is performed, and during the first control, a second control for controlling the actuator 59 based on the EUV energy centroid position is performed. In the second control, when the EUV energy centroid position exceeds the vibration threshold, the actuator 59 is controlled to move the irradiation position in a direction for causing the EUV energy centroid position not to exceed the vibration threshold. Therefore, it is possible to improve the detection sensitivity of the vibration of the EUV energy and prevent generation of the vibration. Thus, the laser irradiation position control in which the influence of the vibration of the EUV energy is suppressed is realized. Further, since generation of fragment debris is prevented by preventing generation of the vibration of the EUV energy, contamination of the EUV light concentrating mirror 23 due to the fragment debris is reduced, and the lifetime of the EUV light concentrating mirror 23 is improved.

### 3.4 Modification

Next, a modification of the EUV light generation system according to the first embodiment will be described. The present modification relates to the position adjustment process executed in the MPL irradiation position adjustment.

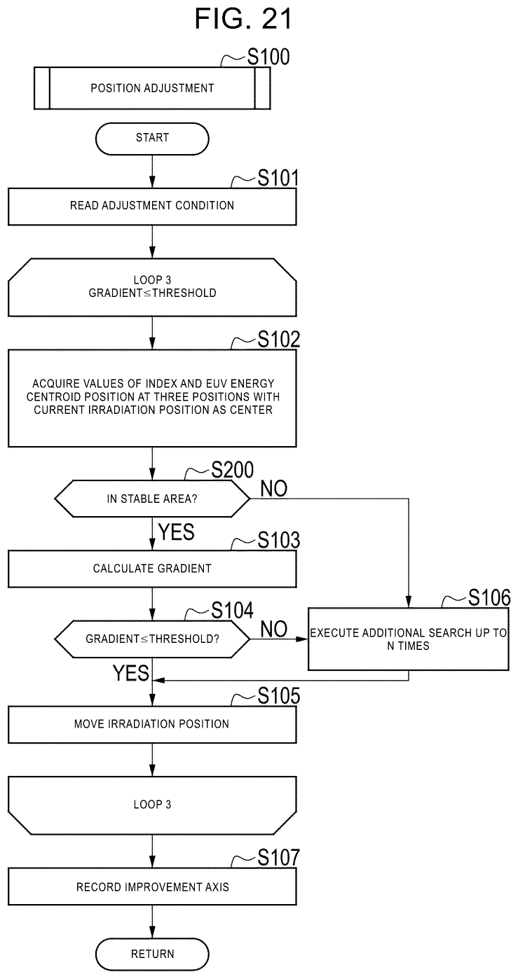

FIG. 21 shows details of the position adjustment process executed in the MPL irradiation position adjustment according to the modification. As shown in FIG. 21, in the present modification, when at least one of the three EUV energy centroid positions is not in the stable area (step S200: NO), the processor 5 advances processing to step S106. That is, in the present modification, step S201 described in the first embodiment does not exist, and the additional search of step S106 corresponds to the vibration avoiding operation. The other processes are similar to those of the first embodiment.

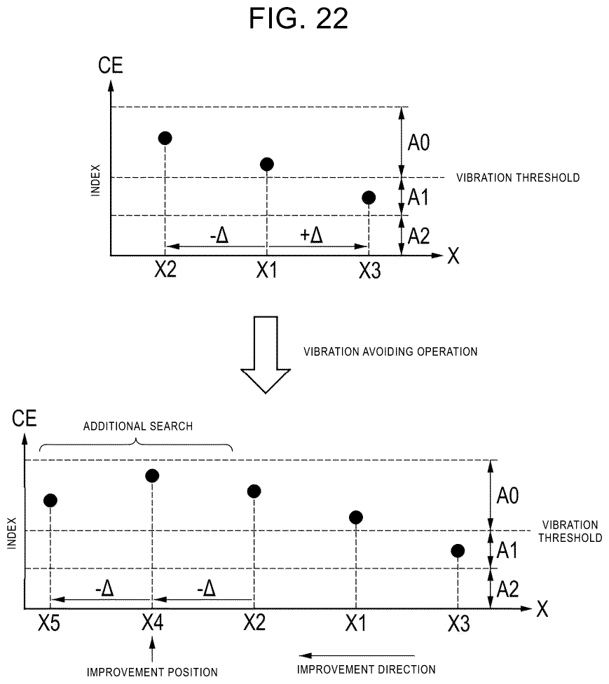

FIG. 22 shows the vibration avoiding operation according to the modification. In the example shown in FIG. 22, since the X-axis coordinate Cx at the search position X3 is not in the stable area A0, that is, exceeds the vibration threshold, the processor 5 executes the vibration avoiding operation by the additional search operation described in the comparative example. In the example shown in FIG. 22, since the direction from the irradiation position X1 toward the search position X2 is the direction in which CE improves, additional search is performed in the direction opposite to the direction from the search position X2 to the irradiation position X1. Since the value of the index at the search position X5 is deteriorated from the value of the index at the search position X4, the search position X4 is the improvement position. The processor 5 moves the irradiation position X1 to the improvement position, and thus the X-axis coordinate Cx at the search position X3 falls within the stable area A0. In the present modification as well, the same effects as in the first embodiment can be obtained.

### 4. Second Embodiment

The EUV light generation system according to a second embodiment will be described. Duplicate description of the same configuration and operation as those of the comparative example will be omitted unless specific description is needed.

### 4.1 Configuration

The configuration of the EUV light generation system according to the present embodiment is similar to the configuration of the EUV light generation system 11 according to the comparative example except that the processor 5 is configured to execute a process different from that in the comparative example.

### 4.2 Operation

In the first embodiment, the EUV light generation system performs determination of the EUV energy centroid position and the vibration avoiding operation during the position adjustment process (step S100) executed in the MPL irradiation position adjustment (step S20). On the other hand, in the present embodiment, the determination of the EUV energy centroid position and the vibration avoiding operation are performed during the position adjustment process (step S100) executed in the light concentrating unit position adjustment (step S10).

The position adjustment process executed in the light concentrating unit position adjustment according to the present embodiment is similar to the position adjustment process shown in FIG. 21 except that the index is E3σ and the irradiation position is moved by moving the light concentrating unit 60 by controlling the stage 84. Therefore, in the present embodiment, the first control for controlling the light concentrating unit 60 based on E3σ is performed, and during the first control, the second control for controlling the stage 84 based on the EUV energy centroid position is performed. Here, E3σ is an example of the “first index related to output values of a plurality of EUV energy sensors” according to the technology of the present disclosure. The EUV energy centroid position corresponds to the “second index related to a ratio among the output values of EUV energy sensors” according to the technology of the present disclosure. Further, the stage 84 is an example of the “actuator” according to the technology of the present disclosure.

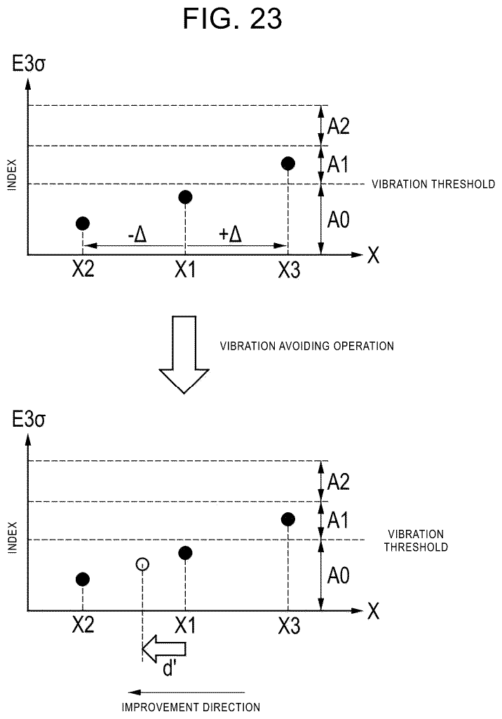

FIG. 23 shows an example of the vibration avoiding operation according to the second embodiment. In the example shown in FIG. 23, since the X-axis coordinate Cx at the search position X3 is not in the stable area A0, that is, exceeds the vibration threshold, the processor 5 executes the vibration avoiding operation. In the vibration avoiding operation, the processor 5 moves the irradiation position X1 in a direction for causing the X-axis coordinate Cx at the search position X3 not to exceed the vibration threshold. The processor 5 moves the irradiation position X1 by the distance d′ in a direction in which E3σ improves, and thus the X-axis coordinate Cx at the search position X3 falls within the stable area A0. The processor 5 may perform determination based on the X-axis coordinates Cx of the EUV energy centroid positions at the three positions X1, X2, X3.

In the present embodiment, since the actuator for changing the irradiation position in the vibration avoiding operation is different from that in the first embodiment, the vibration threshold is a value different from that in the first embodiment. In the present embodiment, in the vibration threshold acquisition process, the EUV energy centroid position and the vibration index value are acquired while changing the irradiation position of the PPL light 31P and the MPL light 31M on the target 27 repeatedly by a predetermined amount by controlling the stage 84 to move the light concentrating unit 60. Other operation of the EUV light generation system according to the present embodiment is similar to that in the first embodiment.

### 4.3 Effect

As described above, in the present embodiment, the first control for controlling the stage 84 based on E3σ is performed, and during the first control, the second control for controlling the stage 84 based on the EUV energy centroid position is performed. In the second control, when the EUV energy centroid position exceeds the vibration threshold, the stage 84 is controlled to move the irradiation position in a direction for causing the EUV energy centroid position not to exceed the vibration threshold. Thus, in the present embodiment, since the second control is performed during the first control, the detection sensitivity of vibration of the EUV energy is improved, and generation of the vibration can be prevented. Thus, the laser irradiation position control in which the effect of the vibration of the EUV energy is suppressed is realized. Further, since generation of fragment debris is prevented by preventing generation of the vibration of the EUV energy, contamination of the EUV light concentrating mirror 23 due to the fragment debris is reduced, and the lifetime of the EUV light concentrating mirror 23 is improved.

The present embodiment can also be modified in a similar manner as the first embodiment. That is, when the EUV energy centroid position exceeds the vibration threshold in the position adjustment process executed in the light concentrating unit position adjustment, the vibration avoiding operation by the additional search operation may be executed.

### 5. Third Embodiment

The EUV light generation system according to a third embodiment will be described. Duplicate description of the same configuration and operation as those of the comparative example will be omitted unless specific description is needed.

### 5.1 Configuration

The configuration of the EUV light generation system according to the present embodiment is similar to the configuration of the EUV light generation system 11 according to the comparative example except that the processor 5 is configured to execute a process different from that in the comparative example.

### 5.2 Operation

In the present embodiment, the EUV light generation system performs the determination of the EUV energy centroid position and the vibration avoiding operation in both the position adjustment process (step S100) executed in the MPL irradiation position adjustment (step S20) and the position adjustment process (step S100) executed in the light concentrating unit position adjustment (step S10). The position adjustment process executed in the MPL irradiation position adjustment is similar to that of the first embodiment. The position adjustment process executed in the light concentrating unit position adjustment is similar to that of the second embodiment. Other operation of the EUV light generation system according to the present embodiment is similar to that in the first embodiment.

### 5.3 Effect

In the present embodiment, since the determination of the EUV energy centroid position and the vibration avoiding operation are performed in both the position adjustment process executed in the MPL irradiation position adjustment and the position adjustment process executed in the light concentrating unit position adjustment, occurrence of vibration of the EUV energy can be prevented more effectively. Thus, contamination of the EUV light concentrating mirror 23 due to the fragment debris is reduced, and the lifetime of the EUV light concentrating mirror 23 is improved.

The present embodiment can also be modified in a similar manner as the first embodiment. That is, when the EUV energy centroid position exceeds the vibration threshold in the position adjustment process executed in the MPL irradiation position adjustment and the light concentrating unit position adjustment, the vibration avoiding operation by the additional search operation may be executed.

### 6. Modification

Next, various modifications common to the first to third embodiments will be described. In the above embodiments, the EUV energy sensors 70a to 70c are arranged on the same plane. However, as long as the distance from the plasma generation region R1, the azimuth angle, and the vertex angle are known, the EUV energy sensors 70a to 70c may not be arranged on the same plane. In this case, the EUV energy centroid position can be acquired based on an expression different from the above expressions (2) and (3). The number of the EUV energy sensors is not limited to three, and may be four or more.

In the above embodiments, the EUV light concentrating mirror 23 has a rotationally symmetric shape with respect to the optical axis of the pulse laser light 31, but may be an off-axis mirror having an asymmetric shape with respect to the optical axis of the pulse laser light 31. In this case, the EUV light generation system may perform the position control process using an index considering the arrangement direction and the light concentrating solid angle of the EUV light concentrating mirror instead of CE. For example, instead of CE, an index E_{IF,OP} represented by the following expression (10) may be used.

$$\begin{matrix}[ Expression 10 ] & \\ {E}_{IF , OP} = ( \frac{1}{m} {\sum }_{j = 1}^{m} {k}_{j} {E}_{j} ) / {E}_{M P L} & ( 10 )\end{matrix}$$

Here, m represents the number of the EUV energy sensors.

Eⱼ represents the output value of the j-th EUV energy sensor. Further, kⱼ represents the coefficient for the j-th EUV energy sensor. E_{MPL} represents the MPL energy. When m=3 and kⱼ=1, the index E_{IF,OP} is CE.

In each of the above-described embodiments, the external apparatus 6 is an exposure apparatus, but the external apparatus 6 may be an inspection apparatus for inspecting a mask on which a device pattern to be transferred to a semiconductor wafer is formed. In this case, the EUV light concentrating mirror 23 may be a grazing incidence type.

### 7. Others

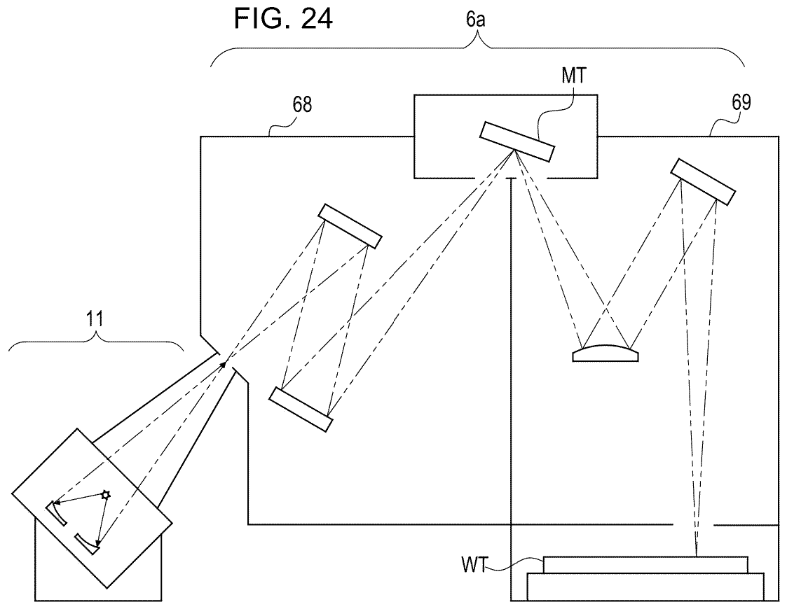

FIG. 24 schematically shows the configuration of an exposure apparatus 6a connected to the EUV light generation system 11. In FIG. 24, the exposure apparatus 6a as the external apparatus 6 includes a mask irradiation unit 68 and a workpiece irradiation unit 69. The mask irradiation unit 68 illuminates, via a reflection optical system, a mask pattern of a mask table MT with the EUV light incident from the EUV light generation system 11. The workpiece irradiation unit 69 images the EUV light reflected by the mask table MT onto a workpiece (not shown) arranged on a workpiece table WT via the reflection optical system. The workpiece is a photosensitive substrate such as a semiconductor wafer on which photoresist is applied. The exposure apparatus 6a synchronously translates the mask table MT and the workpiece table WT to expose the workpiece to the EUV light reflecting the mask pattern. Through the exposure process as described above, a device pattern is transferred onto the semiconductor wafer, thereby an electronic device can be manufactured.

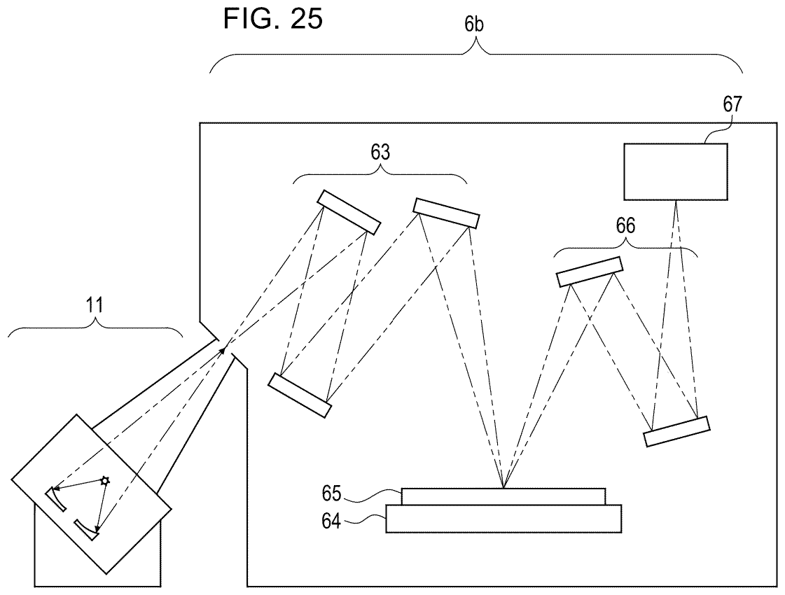

FIG. 25 schematically shows the configuration of an inspection apparatus 6b connected to the EUV light generation system 11. In FIG. 25, the inspection apparatus 6b as the external apparatus 6 includes an illumination optical system 63 and a detection optical system 66. The EUV light generation system 11 outputs, as a light source for inspection, EUV light to the inspection apparatus 6b. The illumination optical system 63 reflects the EUV light incident from the EUV light generation system 11 to illuminate a mask 65 placed on a mask stage 64. Here, the mask 65 conceptually includes a mask blanks before a pattern is formed. The detection optical system 66 reflects the EUV light from the illuminated mask 65 and forms an image on a light receiving surface of a detector 67. The detector 67 having received the EUV light obtains an image of the mask 65. The detector 67 is, for example, a time delay integration (TDI) camera. A defect of the mask 65 is inspected based on the image of the mask 65 acquired by the above-described process, and a mask suitable for manufacturing an electronic device is selected using the inspection result. Then, the electronic device can be manufactured by exposing and transferring the pattern formed on the selected mask onto the photosensitive substrate using the exposure apparatus 6a.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. An EUV light generation system, comprising:
a chamber into which a buffer gas is supplied;
a laser device configured to output laser light to be radiated to a target supplied into the chamber;
an actuator configured to change an irradiation position of the laser light on the target;
a plurality of EUV light sensors configured to detect EUV energy which is energy of EUV light radiated from the target irradiated with the laser light; and
a processor configured to control the actuator,
the processor executing:
a first control of acquiring a value of a first index related to output values of the plurality of EUV energy sensors, acquiring a value of a second index related to a ratio of the output values of the plurality of EUV energy sensors, and controlling the actuator based on the value of the first index; and
a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.

2. The EUV light generation system according to claim 1,
wherein the processor previously acquires and holds the vibration threshold.

3. The EUV light generation system according to claim 1,
further comprising a laser energy sensor configured to detect energy of main pulse laser light,
wherein the laser light includes prepulse laser light to be radiated to the target and the main pulse laser light to be radiated to the target which has been diffused by irradiation with the prepulse laser light,
the first index is a value obtained by dividing a sum or an average of the output values of the plurality of the EUV energy sensors by the energy of the main pulse laser light, and
the processor controls the actuator to control an irradiation position of the main pulse laser light on the target in the first control.

4. The EUV light generation system according to claim 3,
wherein the actuator changes posture of a mirror which reflects the main pulse laser light to change the irradiation position.

5. The EUV light generation system according to claim 1,
wherein the first index is an index indicating temporal deviation of the EUV energy.

6. The EUV light generation system according to claim 5,
wherein the laser light includes prepulse laser light to be radiated to the target and main pulse laser light to be radiated to the target which has been diffused by irradiation with the prepulse laser light, and
the processor controls the actuator to control an irradiation position of the prepulse laser light and an irradiation position of the main pulse laser light on the target.

7. The EUV light generation system according to claim 6,
wherein the actuator is a stage configured to move a light concentrating unit which concentrates the prepulse laser light and the main pulse laser light on the target.

8. The EUV light generation system according to claim 1,
wherein the second index is a centroid position of the EUV energy.

9. The EUV light generation system according to claim 1,
wherein the processor acquires values of the first index at three positions with a current irradiation position as a center, calculates a gradient based on the values of the first index at the three positions, and executes the first control based on the gradient.

10. The EUV light generation system according to claim 9,
wherein the processor moves the irradiation position based on the gradient in the first control in a direction for improving the value of the first index.

11. The EUV light generation system according to claim 9,
wherein, in the second control, the processor acquires values of the second index at the three positions, and controls the actuator to move the irradiation position of the laser light in a direction for causing the value of the second index not to exceed the vibration threshold when at least one of the acquired values of the second index has exceeded the vibration threshold.

12. The EUV light generation system according to claim 1,
further comprising an EUV light concentrating mirror configured to reflect and concentrate the EUV light.

13. An electronic device manufacturing method, comprising:
outputting EUV light generated by an EUV light generation system to an exposure system; and
exposing a photosensitive substrate to the EUV light in the exposure apparatus to manufacture an electronic device,
the EUV light generation system including:
a chamber into which a buffer gas is supplied;
a laser device configured to output laser light to be radiated to a target supplied into the chamber;
an actuator configured to change an irradiation position of the laser light on the target;
a plurality of EUV light sensors configured to detect EUV energy which is energy of the EUV light radiated from the target irradiated with the laser light; and
a processor configured to control the actuator, and
the processor executing:
a first control of acquiring a value of a first index related to output values of the plurality of EUV energy sensors, acquiring a value of a second index related to a ratio of the output values of the plurality of EUV energy sensors, and controlling the actuator based on the value of the first index; and
a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.

14. An electronic device manufacturing method, comprising:
inspecting a defect of a mask by irradiating the mask with EUV light generated by an EUV light generation system;
selecting a mask using a result of the inspection; and
exposing and transferring a pattern formed on the selected mask onto a photosensitive substrate,
the EUV light generation system including:
a chamber into which a buffer gas is supplied;
a laser device configured to output laser light to be radiated to a target supplied into the chamber;
an actuator configured to change an irradiation position of the laser light on the target;
a plurality of EUV light sensors configured to detect EUV energy which is energy of the EUV light radiated from the target irradiated with the laser light; and
a processor configured to control the actuator, and
the processor executing:
a first control of acquiring a value of a first index related to output values of the plurality of EUV energy sensors, acquiring a value of a second index related to a ratio of the output values of the plurality of EUV energy sensors, and controlling the actuator based on the value of the first index; and
a second control of, during the first control, controlling the actuator to move the irradiation position of the laser light in a direction for causing the value of the second index not to exceed a vibration threshold when the value of the second index has exceeded the vibration threshold which reflects a vibration occurrence irradiation position being the irradiation position at which the EUV energy temporally vibrates due to the buffer gas.
